(19) United States
(12) Patent Application Publication
(10) Pub. No.: US 2010/0176329 A1
(43) Pub. Date: Jul. 15, 2010

(54) Regulating valve

(75) Inventor: Jan Meulenbeld, Breckerfeld (DE)

Correspondence Address: COHEN, PONTANI, LIEBERMAN & PAVANE LLP, 551 FIFTH AVENUE, SUITE 1210, NEW YORK, NY, 10176, US

(73) Assignee: DORMA GMGH & CO. KG, ENNEPETAL (DE)

(21) Appl. No.: 12/667,085

(22) PCT Filed: Jun. 9, 2008
(86) PCT No.: PCT/EP08/04578

§ 371 Date: Dec. 29, 2009

(30) Foreign Application Priority Data
Jun. 29, 2007 (DE) 20-2007-009-175.3

(51) Int. Cl. F16K 51/00

(52) U.S. Cl. 251/366

(57) ABSTRACT

A regulating valve, which is attachable in particular in a bore, executed with a female thread, of a hydraulic door closer. The regulating valve has a body adjoined by a regulating section and has a thread located at the body. In order to provide a regulating valve which has a simple configuration, and in which an unwanted, independent adjusting of the regulating valve is excluded during operation, at least one prominence is provided in a reception for an insert part. The prominence engages in a surface of an insert part such that, upon an axial rotational movement of the regulating valve, the insert part is moved in rotational direction. The insert part cooperates in a clamping and a sealing manner with the bore or the female thread of the door closer. In one embodiment, the prominences act as a cam for the insert part.

The invention relates to a regulating valve, which is attachable in particular in a bore, which is executed with a female thread, of a hydraulic door closer, which valve has a body adjoined by a regulating section, and has a thread located at the body and screwed into the female thread of the bore of a hydraulic door closer, the body having a reception with prominences engaging in a surface of a mounted insert part.

The document DE 102 28 872 B4 discloses a regulating valve for a door closer consisting of a body and of a regulating section. For the purpose of regulating the regulating valve, the body has a thread which can be screwed into a bore of the door closer. In this case, the regulating section has a bush-type execution and is connected to the body via a ball-joint connection. In order to prevent the regulating valve, in particular the regulating section, from unwanted rotation, an anti-rotation means is provided, which is formed as an extension or as a protuberance disposed at the regulating section. This extension is longitudinally guided in a groove within the housing of the door closer.

It is the object of the present invention to provide a regulating valve of the species described in the introduction, which has a simple configuration, wherein an unwanted, independent adjustment of the regulating valve is excluded during operation.

As a solution to this problem, a regulating valve having the features of claim 1 is proposed. Preferred further developments are set forth in the dependent claims.

According to the invention, it is intended to provide at least one prominence in a reception, in which an insert part is mounted, the prominence being notch-shaped executed in the section which engages in a surface of an insert part. The raised area can thereby engage in the surface of an insert part and act like a cam for the insert part.

Thereby, a clamping and sealing effect is achieved even during an axial rotational movement. Furthermore, the clamping effect avoids an unintentional, independent releasing or rotating of the regulating valve.

The insert part being deformable is of particular advantage. Thereby, the prominence can easily engage in a surface of an insert part. Likewise, tolerance ranges can be bridged.

Another advantage is that the insert part cooperates in a sealing manner with the bore or the female thread of the door closer. The required sealing function is thereby realized.

A further improvement is achieved in that the prominence engages in a surface of a mounted insert part so as to move the insert part in the rotational direction upon an axial rotational movement of the regulating valve, the insert part cooperating with the bore or the female thread of the door closer in a clamping manner and with a friction torque. The external diameter of the insert part is larger than the diameter of the bore or of the female thread of the door closer. The friction torque of the insert part at the bore or at the female thread of the door closer is thereby increased.

Obviously, several prominences can be provided in the reception. It is likewise conceivable to provide prominences which are disposed within the reception at opposite surfaces.

The following Figures are included to illustrate the solution, in which

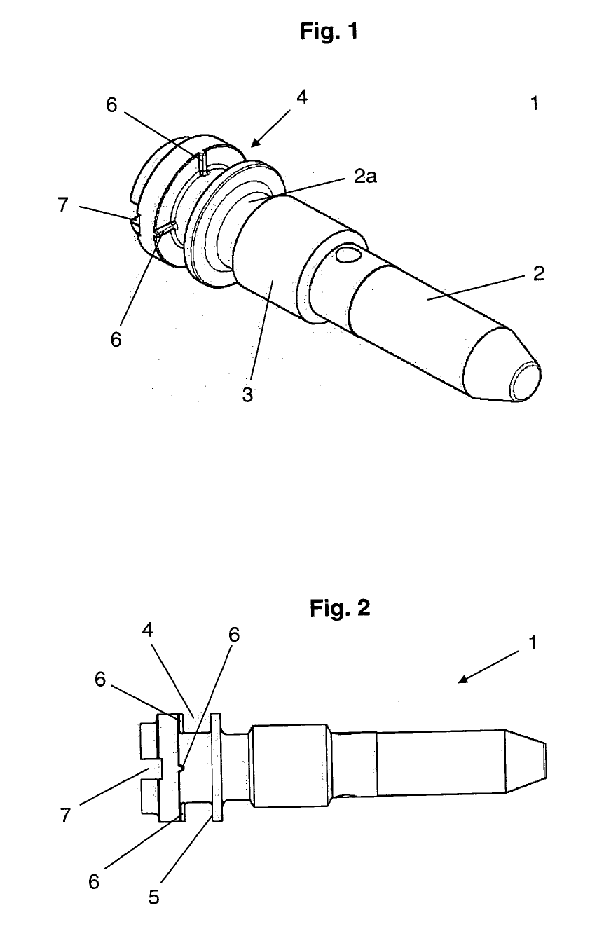

FIG. 1 shows the inventive regulating valve in a perspective view,

FIG. 2 shows the inventive regulating valve of FIG. 1 in a lateral view,

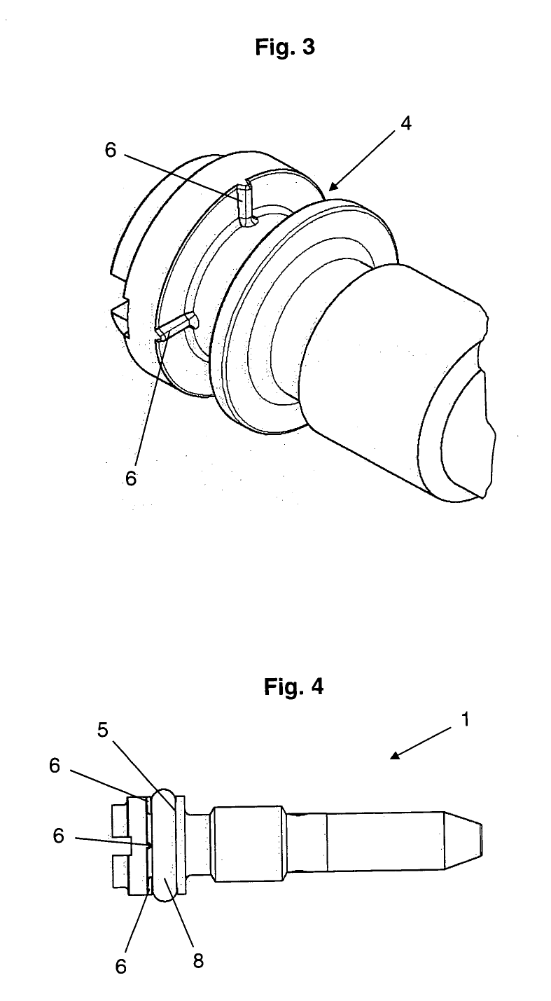

FIG. 3 shows a detailed view of the regulating valve of FIG. 1,

FIG. 4 shows the inventive regulating valve of FIG. 1 with a mounted insert part in a lateral view.

FIG. 1 shows a regulating valve 1, which is provided for a hydraulic door closer. In this case, various door closers can be considered, which for example can be operated by an eccentric cam disc according to DE 103 61 085 A1 or by a toothed rack according to DE 199 01 234 C1. The regulating valve 1 comprises a regulating section 2 and of a body 2a. The regulating section 2 is located at one end of the regulating valve 1 and an actuating section 7 is located at the end opposite the regulating section 2. A thread 3 as well as a reception 4 having prominences 6 are located between these ends.

FIG. 2 shows the regulating valve 1 in a lateral view. Prominences 6 are located in the section of the reception 4, and on the opposite side of the prominences 6, an abutting surface 5 is located within the reception 4. The regulating valve 1 has an actuating section 7 at one end of the regulating valve 1 (in this case, on the left side of the illustration).

FIG. 3 shows a detailed view of FIG. 1, in which the prominences 6 are illustrated within the reception 4.

FIG. 4 shows the regulating valve 1 with a mounted insert part 8 in a lateral view. The prominences 6 act against one side of the insert part 8 and press the insert part 8 against the abutting surface 5, located on the opposite side of the prominences 6.

### LIST OF REFERENCES

1 regulating valve
2 regulating section
2a body
3 thread
4 reception
5 abutting surface
6 prominence
7 actuating section
8 insert part

1.-4. (canceled)

5. A regulating valve, attachable in a bore with a female thread of a hydraulic door closer, the regulating valve comprising:
a body adjoined by a regulating section,
a thread located at the body and threadably insertable into the female thread of the bore of the hydraulic door closer,
an insert part received in a reception on the regulating valve, and
at least one prominence provided in the reception for the insert part,
wherein the prominence is notch-shaped in a section engaging in a surface of the insert part.

6. The regulating valve according to claim 5, wherein the insert part is elastically deformable.

7. The regulating valve according to claim 5, wherein the insert part cooperates in a sealing manner with the bore or the female thread of the door closer.

8. The regulating valve according to claim 5, wherein the prominence engages in a surface of an insert part such that, during an axial rotational movement of the regulating valve, the insert part is moved in rotational direction, the insert part cooperating with the bore or with the female thread of the door closer to produce a clamping effect preventing unintentional rotating of the regulating valve.
